(19) United States
(12) Patent Application Publication
(10) Pub. No.: US 2006/0271766 A1
(43) Pub. Date: Nov. 30, 2006

(54) Dynamic fetch rate control of an instruction prefetch unit coupled to a pipelined memory system

(75) Inventors: Vladimir Vasekin, Cambridge (GB); Andrew Christopher Rose, Cambridge (GB); David Kevin Hart, Cambridge (GB); Daniel Paul Schostak, Ely (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/138,675

(22) Filed: May 27, 2005

(51) Int. Cl. G06F 9/30

(52) U.S. Cl. 712/207

(57) ABSTRACT

Dynamic fetch rate control for a prefetch unit 4 fetching program instructions from a pipelined memory system 2 is provided. The prefetch unit receives a fetch rate control signal from a fetch rate controller 8. The fetch rate controller 8 is responsive to program instructions currently held within an instruction queue 6 to determine the fetch rate control signal to be generated.

### BACKGROUND OF THE INVENTION

1. Field of the Invention

This invention relates to the field of data processing systems. More particularly, this invention relates to the control of an instruction prefetch unit for fetching program instructions to an instruction queue from within a pipelined memory system.

2. Description of the Prior Art

It is known to provide data processing systems having a prefetch unit operable to fetch program instructions from a pipelined memory system, whether that be an L1 cache, a TCM or some other memory, and supply these fetched program instructions into an instruction queue where they are buffered and ordered prior to being issued to a data processing unit, such as a processor core, for execution. In order to improve memory fetch performance, it is known to utilise pipelined memory systems in which multiple memory accesses can be in progress at any given time. Thus, a prefetch unit may initiate a memory access fetch on one cycle with the data corresponding to that memory access fetch being returned several cycles later. Within a data processing system in which changes in program instruction flow, such as branches, are not identified until after the program instructions are actually returned from the memory, then it is possible that several undesired memory access fetches would have been initiated to follow on from the branch instruction and which are not required since the branch instruction will redirect program flow elsewhere. It can also be the case that exceptions or interrupts can arise during program execution resulting in a change in program flow such that memory access fetches already underway are not required. A significant amount of energy is consumed by such unwanted memory access fetches and this is disadvantageous.

### SUMMARY OF THE INVENTION

Viewed from one aspect the present invention provides a data processing apparatus comprising:

a prefetch unit operable to fetch program instructions from a pipelined memory system;

an instruction queue unit operable to receive program instructions from said prefetch unit and to maintain an instruction queue of program instructions to be passed to a data processing unit for execution; and

a fetch rate controller coupled to said instruction queue unit and responsive to program instructions queued within said instruction queue to generate a fetch rate control signal; wherein

said prefetch unit is responsive to said fetch rate control signal generated by said fetch rate controller to select one of a plurality of target fetch rates for program instructions to be fetched from said pipelined memory system by said prefetch unit, said plurality of target fetch rates including at least two different non-zero target fetch rates.

The present technique recognises that energy is being wasted by performing memory access fetches which will not be required due to changes in program instruction flow. Furthermore, the present technique seeks to reduce this waste of energy by dynamically controlling the fetch rate of the prefetch unit in dependence upon the instructions currently held within the instruction queue. In many cases, the maximum fetch rate is not needed since the instructions will not be issued from the instruction queue to the data processing unit at a rate which needs the maximum fetch rate in order to avoid underflow within the instruction queue. Accordingly, a lower fetch rate may be employed and this reduces the likelihood of memory access fetches being in progress when changes in program instruction flow occur rendering those memory access fetches unwanted. This reduces energy consumption whilst not impacting the overall level of performance since instructions are present within the instruction queue to be issued to the data processing unit when the data processing unit is ready to accept those instructions.

A secondary effect of reducing the number of memory access fetches which are not required is that the probability of cache misses is reduced and accordingly the performance penalties of cache misses can be at least partially reduced.

Whilst it will be appreciated that the fetch rate may be controlled in a wide variety of different ways in dependence upon the program instructions currently stored within the instruction queue, there is a balance between the sophistication and consequent overhead associated with the circuitry for performing this control weighed against the benefit to be gained from more accurate or sophisticated control.

In some simple embodiments of the present technique the fetch rate may be controlled simply in dependence upon how many program instructions are currently queued.

A more sophisticated approach, which is particularly well suited to being matched with the number of stages within the pipelined memory system, is one in which a plurality of occupancy ranges are defined within the instruction queue with the fetch rate being dependent upon which occupancy range currently corresponds to the number of instructions currently queued.

This occupancy range approach is well suited to dynamic adjustment of the control mechanism itself, e.g. underflows of program instructions resulting in a shift in the boundary between occupancy ranges resulting in a tendency to speed up the fetch rate or overflows of the instruction queue shifting the boundaries to result in an overall lowering of the fetch rate.

A more sophisticated and complex control arrangement is one in which the fetch rate controller at least partially decodes at least some of the program instructions within the instruction queue to identify those instructions and accordingly estimate the number of processing cycles which the data processing unit will require to execute those instructions. Thus, an estimate of the total number of processing cycles required to execute the program instructions currently held within the instruction queue may be obtained and this used to control the program instruction fetch rate.

Within some data processing systems multiple program instruction sets are supported and these program instruction sets can have different instruction sizes. In such systems a given fetch from the pipelined memory system may contain a higher number of program instructions if those program instructions are shorter in the length. Accordingly, the fetch rate controller is desirably responsive in at least some embodiments to the currently selected instruction set so that the fetch rate control signal can be adjusted depending upon the currently selected instruction set.

As previously discussed, when a taken branch instruction is encountered this will result in a change in program flow. The present technique helps reduce wasted energy due to unwanted memory access fetches being performed to locations no longer on that program flow. The technique can be further enhanced in at least some embodiments by increasing the fetch rate for a predetermined number of memory access cycles following a taken branch instruction so as to make up for the jump in program flow and refill the instruction queue with a pending workload of program instructions.

The prefetch unit can respond to the fetch rate control signal in a variety of different ways to adjust the overall fetch rate achieved. Particular embodiments are such that the fetch rate control signal controls the prefetch unit to either fetch or not fetch on each memory access cycle with the ratio between memory access cycles when a fetch is or is not performed being dependent upon the fetch rate control signal. Thus, the duty cycle of the prefetch unit is effectively controlled based upon the fetch rate control signal.

Within a two-stage pipelined memory system, a particularly advantageous control mechanism which provides a good degree of energy saving with a relatively low degree of control complexity if one employing fast, medium and low fetch rate control signals, such as may be generated in dependence upon occupancy ranges of the instruction due as previously discussed.

Viewed from another aspect the present invention provides a method of processing data comprising:

fetching program instructions from a pipelined memory system;

receiving said program instructions from said memory and maintaining an instruction queue of program instructions;

in response to program instructions queued within said instruction queue generating a fetch rate control signal; and

in response to said fetch rate control signal selecting one of a plurality of target fetch rates for program instructions to be fetched from said pipelined memory system, said plurality of target fetch rates including at least two different non-zero target fetch rates.

Viewed from a further aspect the present invention provides a data processing apparatus comprising:

a prefetch means for fetching program instructions from a pipelined memory system;

an instruction queue means for receiving program instructions from said prefetch unit and for maintaining an instruction queue of program instructions to be passed to a data processing unit for execution; and

a fetch rate controller means coupled to said instruction queue unit and responsive to program instructions queued within said instruction queue for generating a fetch rate control signal; wherein

said prefetch means is responsive to said fetch rate control signal generated by said fetch rate controller to select one of a plurality of target fetch rates for program instructions to be fetched from said pipelined memory system by said prefetch unit, said plurality of target fetch rates including at least two different non-zero target fetch rates.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a portion of a data processing apparatus comprising a pipelined memory system, a prefetch unit, an instruction queue and a fetch rate controller;

FIG. 2 schematically illustrates an instruction queue with three occupancy ranges and control of the boundaries between those occupancy ranges;

FIG. 3 is a flow diagram schematically illustrating the generation of a fetch rate control signal in dependence upon occupancy range;

FIG. 4 is a flow diagram schematically illustrating the movement of occupancy range boundaries in dependence upon instruction queue underflow or overflow;

FIG. 5 is a flow diagram schematically illustrating the response of a fetch rate control signal to detection of a taken branch instruction; and

FIG. 6 is a flow diagram schematically illustrating an alternative embodiment in which instructions within the instruction queue are at least partially decoded and an estimated total of the processing cycles required to execute the queued instructions is calculated.

### DESCRIPTION OF THE PREFERRED EMBODIMENTS

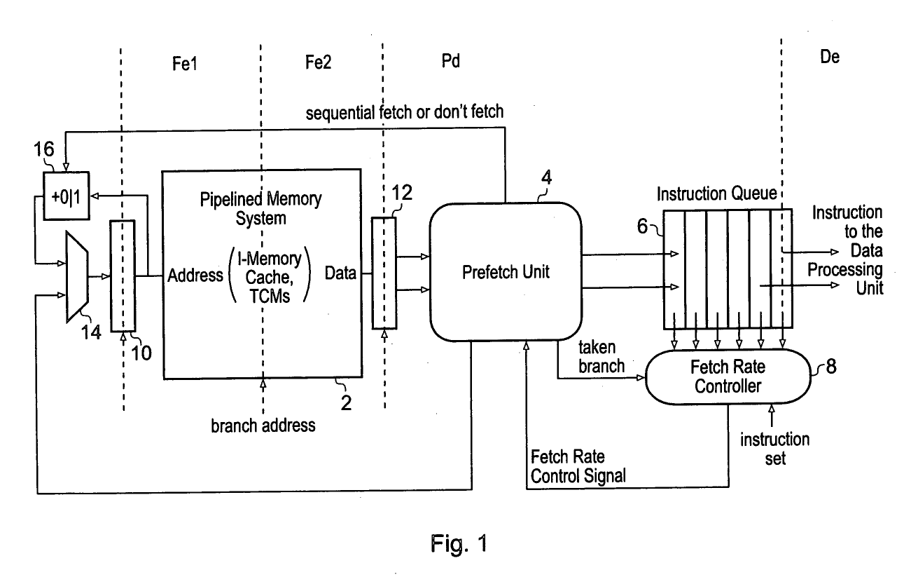

FIG. 1 schematically illustrates a portion of the data processing system including a pipelined memory system 2, such as an instruction memory cache, a tightly coupled memory, etc, a prefetch unit 4, an instruction queue 6 and a fetch rate controller 8. A memory address from which one or more program instructions (depending upon fetch block size and instruction size) is stored within a memory address register 10 and used to address the pipelined memory system 2. A block of instructions (e.g. 64-bits, 128-bits, etc) is read from the pipeline memory system 2 and stored within a fetched block register 12. The prefetch unit 4 reads the fetched block of program instructions and divides these into separate program instructions to be added to the instruction queue 6 as well as identifying branch instructions and applying any branch prediction mechanism. The type of branch prediction mechanism used by the prefetch unit 4 in this embodiment is, for example, a global history register. Global history registers provide a hardware efficient branch prediction mechanism which is able to predict branch outcomes once a branch instruction has been fetched and identified as a branch instruction. If such a taken branch instruction is identified, then the prefetch unit will serve to predict a new memory address from which program instructions are to be fetched and this is supplied via a multiplexer 14 to the memory address register 10. Absent such branch identification, the prefetch unit 4 sequentially increments the memory address within the memory address register 10 using an incrementer 16 whenever the prefetch unit indicates that a next fetch is to be performed. A don't fetch signal will result in the memory address simply being recycled without being implemented, or the memory address could be left static within the memory address register 10.

The program instructions emerging from the prefetch unit 4 are separated into separate program instructions which are passed to the data processing unit (not illustrated) when they emerge from the instruction queue 6. Whilst the program instructions are within the instruction queue 6, the fetch rate controller 8 analyses these queued program instructions to generate a fetch rate control signal which is applied to the prefetch unit 4. The fetch rate control signal is used by the prefetch unit 4 to determine the duty cycle of the fetch or don't fetch signal being applied to the incrementer 16 and accordingly the fetch rate of program instructions from the pipeline memory system 2. The analysis and control of the fetch rate control signal can take a variety of different forms and may also be responsive to a currently selected instruction set within a system supporting multiple instruction sets of different program instruction sizes as well as upon identification of a taken branch instruction by the prefetch unit 4. These control techniques will be discussed below.

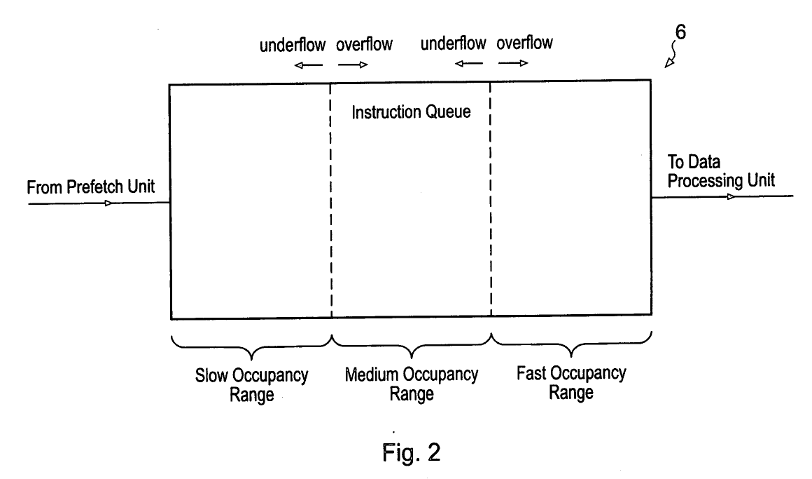

FIG. 2 illustrates the instruction queue 6 divided into different occupancy ranges. At a given point in time, the number of program instructions within the instruction queue 6 will fall within either the fast occupancy range, the medium occupancy range or the slow occupancy range. The slow occupancy range corresponds to the instruction queue 6 being nearly full, whereas the fast occupancy range corresponds to the instruction queue 6 being nearly empty. Depending upon the current occupancy range, the fetch rate controller 8 generates a slow, medium or fast fetch rate control signal to be applied to the prefetch unit 4. Such a fast/medium/slow fetch rate control arrangement is well suited to a two-stage memory pipeline 2 such as illustrated in FIG. 1. Within such a system the prefetch unit 4 generates fetch or don't fetch signals to be applied to the incrementer 16 in dependence upon the fetch rate control signal and the currently pending memory accesses fetches in accordance with the following:

| | | |
|---|---|---|
| Fe1 | Fe2 | Pd |

Slow fetch rate:

| | | | |
|---|---|---|---|
| F | O | O | don't fetch |
| O | F | O | don't fetch |
| O | O | F | fetch |
| F | O | O | don't fetch |

Medium fetch rate:

| | | | |
|---|---|---|---|
| F | F | O | don't fetch |
| O | F | F | fetch |
| F | O | F | fetch |
| F | F | O | don't fetch |

Fast fetch rate:

| | | | |
|---|---|---|---|
| F | F | F | fetch |

O - empty stage
F—fetch

The boundaries between the occupancy ranges illustrated in FIG. 2 need not be static. One or both of these boundaries may be moved in dependence upon the detection of underflow or overflow of the instruction queue 6. In particular, if an underflow occurs, then the boundaries are moved towards the left in FIG. 2 corresponding to a general increase in the target fetch rate. Conversely, should an overflow occur, then the boundaries are moved towards the right in FIG. 2 corresponding to a general decrease in the target fetch rate.

A Verilog description of the fetch rate controller 8 required to produce the functionality described above (or at least been a major part thereof) is given in the following:

// Fetch rate control logic

| | |
|---|---|
| wire fr_empty | =˜valid[0]; |
| wire fr_full | = valid[iq_size−1]; |

//valid[iq_size:0] is one bit per IQ entries vector

| | |
|---|---|
| reg [iq_size−1:0] fr_med_pos; | // medium rate zone start position |
| reg [iq_size−1:0] fr_slw_pos; | // slow rate zone start position |
| always @ (posedge clk ) | |

begin

if ( flush ) // IQ flush

| | |
|---|---|
| begin | //for 8 entries |

| | |
|---|---|
| fr_med_pos <=1; | //00000001 |
| fr_slw_pos <=1<<((iq_size+2)/3); | //00001000 |

end

else

begin

if ( fr_empty & ˜fr_slw_pos[iq_size−1] ) // IQ empty

begin // shift window back

fr_slw_pos <= fr_slw_pos << 1;
fr_med_pos <= fr_med_pos <<1;

end

if (fr_full & ˜fr_med_pos[0] ) // IQ full

begin // shift window forward

fr_slw_pos <= fr_slw_pos >> 1;
fr_med_pos <= fr_med_pos >>1;

end

end

| end | | | |
|---|---|---|---|
| wire fr_medium =\| (fr_med_pos&valid); | | | |
| wire fr_slow =\| (fr_slw_pos&valid) | | | |
| wire [1:0] fetch_rate = | fr_slow | ? ‘SLOW | : |
| | fr_medium | ? ‘MEDIUM | : ‘FAST; |

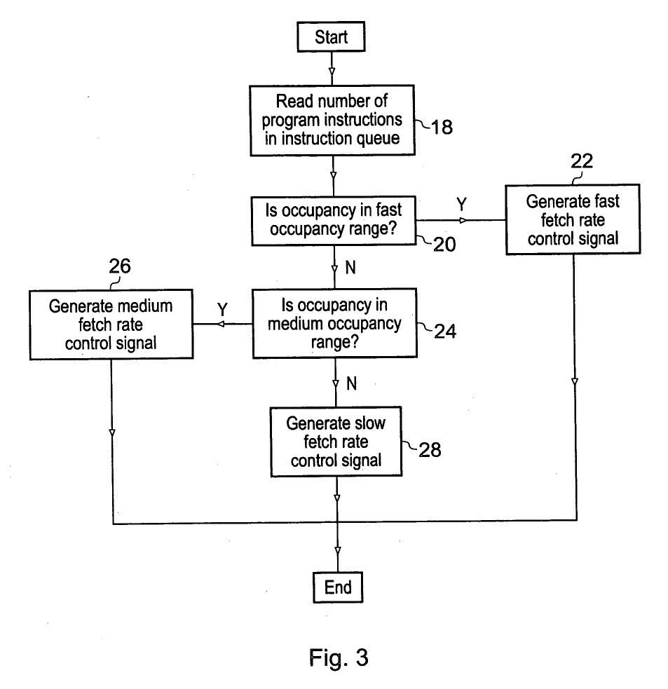

FIG. 3 is a flow diagram schematically illustrating the generation of a fetch rate control signal in dependence upon the current occupancy range. At step 18 the number of program instructions currently within the instruction queue 6 is read by the fetch rate controller 8. At step 20 the fetch rate controller 8 determines whether the current occupancy is in the fast occupancy range. If this is true, then step 22 generates a fast fetch rate control signal and processing terminates. If the determination at step 20 is false, then step 24 determines whether the occupancy is currently within the medium occupancy range. If the determination at step 24 is true, then step 26 generates a medium fetch rate control signal and processing terminates. If the determination at step 24 is false, then processing proceeds to step 28 at which a slow fetch rate control signal is generated before processing terminates. It will be seen from FIG. 3 that the current occupancy is used to determined whether a fast, medium or slow fetch rate control signal is generated.

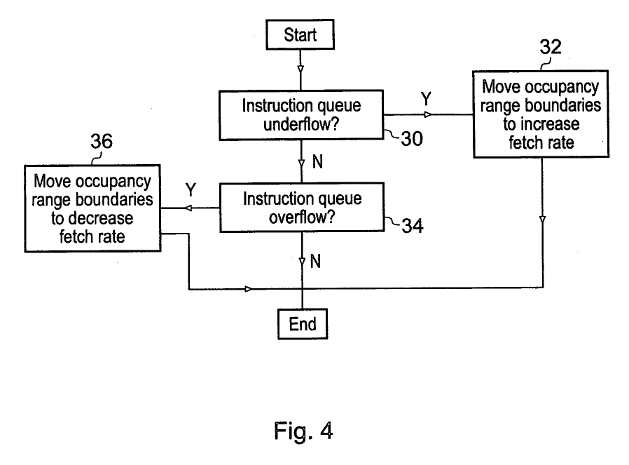

FIG. 4 schematically illustrates the dynamic control of the boundaries between the occupancy ranges illustrated in FIG. 2. At step 30 a determination is made as to whether an instruction queue underflow has occurred. If such an underflow has occurred, then step 32 moves both the occupancy range boundaries of FIG. 2 to increase the overall fetch rate. If the determination at step 30 was false, then step 34 determines whether an instruction queue overflow has occurred. If such an overflow has occurred, then step 36 serves to move both of the occupancy range boundaries of FIG. 2 to give an overall decrease in fetch rate.

It will be appreciated that the operation of the processes of FIGS. 3 & 4 take place continuously and may not be in fact embodied in the form of sequential logic as is implied by the flow diagram. The same is true of the following flow diagrams.

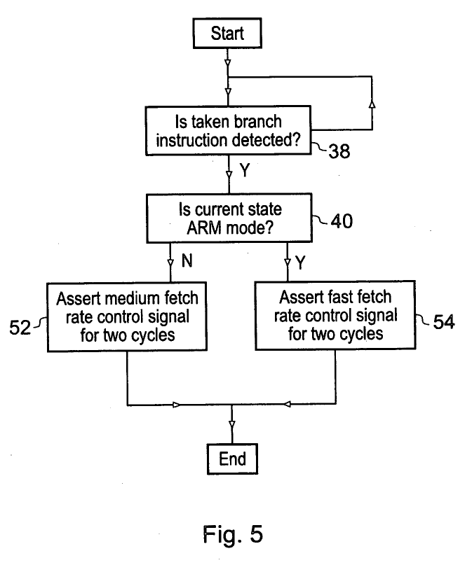

FIG. 5 is a flow diagram illustrating the response of the fetch rate controller 8 to a taken branch being detected. A taken branch is detected within the prefetch unit 4 as part of the branch prediction mechanisms. When such a taken branch is detected at step 38, then processing proceeds to step 40 at which a determination is made as to whether the system is currently operating in ARM mode (long instructions). If the system is in ARM mode, then processing proceeds to step 54 at which a fast fetch rate control signal is asserted for two cycles so as to enable the rapid refilling of the instruction queue 6 following the switch in program instruction flow. If the determination at step 40 is that the system is not in ARM mode, then processing proceeds to step 52 at which a medium fetch rate control signal is asserted for two cycles. If the current instruction set selected as indicated by the instruction set signal applied to the fetch rate controller 8 is one having relatively small program instructions, then the fast fetch rate control signal need not be asserted for two cycles following the taken branch but instead a medium fetch rate control signal is asserted for two cycles. Smaller program instructions mean that when a block of instructions is fetched from the pipeline memory system 2, then this block will tend to contain more individual instructions and accordingly more rapidly refill the instruction queue 6.

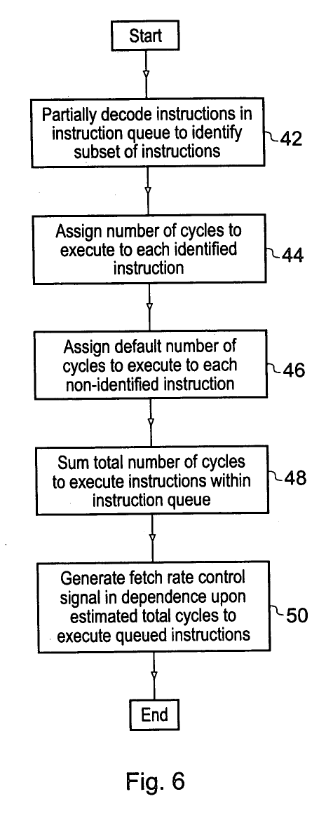

FIG. 6 is a flow diagram schematically illustrating another control technique for the fetch rate controller 8. The fetch rate controller 8 is still responsive to the program instructions stored within the instruction queue 6, but in this case at step 42 it serves to at least partially decode at least some program instructions. The program instructions which it is worthwhile identifying with the fetch rate controller are those known to take a relatively large number of processing cycles to complete, such as within the ARM instruction set LDM, STM instructions or long multiply instructions or the like. Such partial decoding identifies for this group of instructions a number of processing cycles which they will take and this is assigned to the instructions at step 44. The remaining program instructions at step 46 will be assigned a default number of cycles to execute. At step 48 the total number of cycles to execute the currently pending program instructions within the instruction queue 6 is calculated and at step 50 a fetch rate control signal is generated by the fetch rate controller 8 in dependence upon this estimated total number of cycles to execute the pending program instructions.

It will be appreciated that whilst additional control complexity may be necessary to perform such partial decoding, this technique recognises that some program instructions take longer to execute than others and that simply estimating that all program instructions take the same number of processing cycles to execute is inaccurate. The relative benefit between the extra accuracy achieved and the extra control complexity required will vary depending upon the particular intended application and in some applications the extra complexity may not be worthwhile.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A data processing apparatus comprising:
a prefetch unit operable to fetch program instructions from a pipelined memory system;
an instruction queue unit operable to receive program instructions from said prefetch unit and to maintain an instruction queue of program instructions to be passed to a data processing unit for execution; and
a fetch rate controller coupled to said instruction queue unit and responsive to program instructions queued within said instruction queue to generate a fetch rate control signal; wherein
said prefetch unit is responsive to said fetch rate control signal generated by said fetch rate controller to select one of a plurality of target fetch rates for program instructions to be fetched from said pipelined memory system by said prefetch unit, said plurality of target fetch rates including at least two different non-zero target fetch rates.

2. A data processing apparatus as claimed in claim 1, wherein said fetch rate controller generates said fetch rate control signal in dependence upon how many program instructions are queued within said instruction queue, fewer program instructions stored within said instruction queue giving rise to fetch rate control signals corresponding to higher target fetch rates.

3. A data processing apparatus as claimed in claim 1, wherein said fetch rate controller generates said fetch rate control signal in dependence upon a number of program instructions within said instruction queue being within a respective one of a plurality of occupancy ranges, occupancy ranges corresponding to fewer program instructions stored within said instruction queue giving rise to fetch rate control signals corresponding to higher target fetch rates.

4. A data processing apparatus as claimed in claim 3, wherein said fetch rate controller is responsive to an underflow of program instructions within said instruction queue to shift at least one boundary between said plurality of occupancy ranges such that said boundary occurs at a position corresponding to a higher number of program instructions within said instruction queue than before said underflow.

5. A data processing apparatus as claimed in claim 3, wherein said fetch rate controller is responsive to an overflow of program instructions within said instruction queue to shift at least one boundary between occupancy ranges such that said boundary occurs at a position corresponding to a lower number of program instructions than before said overflow.

6. A data processing apparatus as claimed in claim 4, wherein all of said boundaries between said plurality of occupancy ranges are shifted by the same amount.

7. A data processing apparatus as claimed in claim 5, wherein all of said boundaries between said plurality of occupancy ranges are shifted by the same amount.

8. A data processing apparatus as claimed in claim 1, wherein said fetch rate controller at least partially decodes said program instructions stored within said instruction queue to identify at least some program instructions in order to generate an estimate of how many processing cycles of said data processing unit will be required to execute said program instructions stored within said instruction queue and generates said fetch rate control signal in dependence upon said estimate.

9. A data processing apparatus as claimed in claim 1, wherein said data processing unit is operable to execute program instructions from a selectable one of a plurality of instruction sets, different instruction sets having different instruction lengths, and said fetch rate controller generates said fetch rate control signal in dependence upon which instruction set is currently selected such that when an instruction set having smaller program instructions is selected, said fetch rate control signal will correspond to a lower target fetch rate.

10. A data processing apparatus as claimed in claim 1, wherein said fetch rate controller is responsive to a taken branch instruction within said program instructions to generate a fetch rate control signal to temporarily increase said target fetch rate following said taken branch instruction.

11. A data processing apparatus as claimed in claim 1, wherein said prefetch unit is responsive to said fetch rate control signal to either fetch or not fetch on each memory access cycle with a ratio between memory access cycles when a fetch is performed and memory access cycles when a fetch is not performed that is dependent upon said fetch rate control signal.

12. A data processing apparatus as claimed in claim 1, wherein said pipelined memory system comprises a two stage pipelined memory system and said at least two non-zero target fetch rates comprise a fast rate, a medium rate less than said fast rate and a slow rate less than said medium rate.

13. A method of processing data comprising:
fetching program instructions from a pipelined memory system;
receiving said program instructions from said memory and maintaining an instruction queue of program instructions;
in response to program instructions queued within said instruction queue generating a fetch rate control signal; and
in response to said fetch rate control signal selecting one of a plurality of target fetch rates for program instructions to be fetched from said pipelined memory system, said plurality of target fetch rates including at least two different non-zero target fetch rates.

14. A data processing apparatus comprising:
a prefetch means for fetching program instructions from a pipelined memory system;
an instruction queue means for receiving program instructions from said prefetch unit and for maintaining an instruction queue of program instructions to be passed to a data processing unit for execution; and
a fetch rate controller means coupled to said instruction queue unit and responsive to program instructions queued within said instruction queue for generating a fetch rate control signal; wherein
said prefetch means is responsive to said fetch rate control signal generated by said fetch rate controller to select one of a plurality of target fetch rates for program instructions to be fetched from said pipelined memory system by said prefetch unit, said plurality of target fetch rates including at least two different non-zero target fetch rates.
